(19) United States
(12) Patent Application Publication
(10) Pub. No.: US 2007/0098368 A1
(43) Pub. Date: May 3, 2007

(54) MOBILE RECORDING STUDIO SYSTEM

(76) Inventors: Thomas Carley, West Warwick, RI (US); Anthony P. M. Ricci, Woonsocket, RI (US)

Correspondence Address: CERMAK & KENEALY LLP, 515 E. BRADDOCK RD, SUITE B, ALEXANDRIA, VA, 22314, US

(21) Appl. No.: 11/419,786

(22) Filed: May 23, 2006

Related U.S. Application Data
(60) Provisional application No. 60/732,157, filed on Nov. 2, 2005.

(51) Int. Cl. H04N 7/00

(52) U.S. Cl. 386/96

(57) ABSTRACT

A stand-alone performance recording system includes an enclosure or performance area adapted to be moved from a first location to a second location, and temporarily, semi-permanently or permanently set up at the second location for the purpose of recording the audio and/or visual aspects of an event performed within the enclosure. Digital audio and video recording are performed within the enclosure. A controlled environment is provided within the enclosure, and the recording system includes features that allow for the superposing and/or editing of multiple live and prerecorded audio and/or video inputs provided within the stand-alone enclosure during an event performed within the enclosure at whatever location is desired.

This application claims priority under 35 U.S.C. § 119 to U.S. provisional patent application No. 60/732,157, filed 2 Nov. 2005, for “Mobile Recording Studio System”, the entirety of which is incorporated by reference herein.

### BACKGROUND

A performance recording system is provided as a modular enclosure that can be moved from a first location to a second location and set up temporarily, semi-permanently, or permanently at the second location, and that comprises equipment and features that allow for the production of a high quality recording of a performance conducted within the enclosure.

### SUMMARY

A recording system includes a modular enclosure within which an individual or group can perform audibly and/or visually. An environment control system can be provided and adapted for controlling the environment within the modular enclosure during a performance occurring within the enclosure. The modular enclosure can also include an audio recording device, a video recording device, a playback system including one or more audio and video playback capabilities, a digital signal processing system that includes an audio processing module and a video processing module, and a central processing unit adapted to process inputs from one or more of the audio recording device, the video recording device, the playback system and the digital signal processing system and produce a recording of the audible and/or visual performance performed within the enclosure.

The modular enclosure can be adapted to be carried on a trailer, or it can be adapted to be disassembled and carried to a location using a vehicle such as an automobile or sport utility vehicle. Alternatively, the modular enclosure can be moved from a first location to a second location such as a retail location, where it can be permanently established.

The environment control system can include one or more of a climate control system, an interchangeable backdrop with selectable images, olfactory stimulation device, tactile stimulation device, TV monitor adapted to replay one or more of prerecorded audio and visual effects comprising song lyrics, music and video, and a fold-down stage adapted to raise the level of a performer within the enclosure, and lighting effects.

### BRIEF DESCRIPTION OF THE DRAWINGS

FIG. 1 is a schematic drawing of an embodiment of a performance recording enclosure.

FIG. 2 is a flow diagram showing the interrelationship between features of an exemplary embodiment of a performance recording system.

FIG. 3 is a flow diagram showing further interrelationships between additional features of an exemplary embodiment of a performance recording system.

### DETAILED DESCRIPTION OF PREFERRED EMBODIMENTS

A stand-alone performance recording studio system according to one embodiment of the disclosed subject matter can include an enclosure adapted to be moved from a first location to a second location, and temporarily, semi-permanently, or permanently set up at the second location for the purpose of recording the audio and/or visual aspects of an event performed within the enclosure. The recording system can be capable of digital audio and video recording. The recording system can be provided with a controlled environment, adapted to be set up at any location, and adapted to be operated by manual and/or automated means. The recording system also can include features that allow for the superimposing and/or editing of multiple audio and/or video inputs provided within the stand-alone enclosure during an event performed within the enclosure at whatever location is desired.

The recording system can be adapted to create recorded outputs comparable to large scale audio/video production and post-production outputs in real or near-real time, at a location other than a traditional fixed recording facility, delivered directly to a customer's electronic format of choice or to any standard or non-standard digital storage media. The user of this recording system is provided with a means for digitally recording and electronically enhancing their individual performance wherever the stand-alone recording system is located.

The stand alone recording system is also capable of being used as a music composition station, where the customer can create an original piece of music on the spot using methods including assembly of prerecorded digital “loops” of royalty-free real instrument performances, which are automatically adapted to fit the tempo and key signature of the composition, by playing original beats and melodies using a “control surface” such as a keyboard or percussion pads which trigger “virtual instruments”, and by adding prerecorded “MIDI loops” which are prerecorded performances that can be assigned to any virtual instrument or sound the customer wants. This can be done with the assistance and guidance of a staff member, or without any assistance in the automated version (Soundbox Automatic). This feature will include the addition of one or multiple digital controllers (“control surfaces”, physical or virtual).

The stand-alone recording system according to various embodiments can allow individuals and groups to have access to high quality recordings of themselves performing alone, or with prerecorded backing accompaniment, at a location convenient to that customer, and then to receive a “master” recording in electronic or physical format. This type of controlled environment recording and enhancement has, in the past, typically required booking a studio, an engineer, a producer, and cost hundreds, thousands, or tens of thousands of dollars. The benefits of conventional recording studios can be achieved by the stand-alone recording system, with the additional benefits that include, but are not limited to, achieving a high quality recording with a single transaction, in a mobile operation that can be brought to a customer's particular location or provided in multiple central locations such as malls if desired, and at a fraction of the cost of a traditional professional recording studio.

The system will allow for the creation of and on the spot manufacture and duplication of custom media (CD, DVD or any digital storage device) containing either or both the original compositions created at the recording facility, and legal downloads of commercial recordings owned by other artists or companies selected and purchased at the facility.

System components of a stand-alone recording system according to various embodiments can include a controlled recording environment within a modular enclosure that serves as the studio for an individual or group performance, and that can be moved from a first location to a second location and set up temporarily, semi-permanently, or permanently at the second location. The recording system can comprise one or more features such as:
Climate control
Video lighting
Motivational lighting
Optional olfactory stimulation
Soundproofing
Audio playback monitor system (both global with speakers and personal with headphones)
Video monitor system, including a tele-prompter device and a composite output monitor for the performer.
Electronic communication system (“talkback”)
Internal acoustic-optimization treatments
Selectable visual backdrops, both real and electronic
Audio capture devices (wired and wireless microphones)
Video capture devices (single and multi-CCD devices, variable focus and fields)

A digital signal processing station (manual or automated), can also be provided, and can include one or more features such as:
an audio processing module, wherein the audio processing module can include any or all of the following:
   Filters and frequency equalization
   Dynamic range compression
   Dynamic range limiting
   Sibilance attenuation (“de-essing”)
   Digital microphone “modeling”
   Noise reduction
   Pitch correction
   Electronic double-tracking
   Environment simulation, wherein environment simulation can include any or all of the following:
   Time delay (echo)
   Room equalization
   Acoustic space simulation (reverb)
   Voice alteration and effects, to transform or simulate:
   male to female
   female to male
   adult to child
   child to adult
   small creature
   large creature
   “lo-fi”, or am radio simulation
   overdrive and distortion
a video processing module, wherein the video processing module can provide digital video mixing and blending of multiple input sources, including:
   Multiple live camera inputs
   Prerecorded and live video background inputs
   Video effects processing (real time, automated and sequenced), including, but not limited to:
   Negative effect
   Strobe effect
   Sepia effect
   Mosaic effect
   Black and white effect
   Chroma keying, to replace the real background with digitally generated images and alternate video sequences as background
   Luma keying
   Compositing
   Superimposing
   Multiple transitions, or “wipes”
   Various visual distortion and enhancement effects

Audio and video element generators and playback units can also be provided. These elements can include one or more of at least the following devices:
Audio CD player (and prerecorded content)
DVD Video player (and prerecorded content)
Random Access storage and playback devices
Electronic signal generators

A digital capture and editing station can be provided, and can comprise a computer based workstation used for editing the recorded performance and preparing the digital files for output.

A secondary editing and media creation station can also be provided, and can comprise a computer based workstation used for assembling the prepared files into the final master, controlling the duplication machines, providing for artistic design of the final master, and control of graphic printing machines which can add custom artwork to a physical master or copy.

A primary storage device can also be provided to store the initial unique digital output created by the above systems.

A secondary storage device can be provided that is adapted to receive and store the output from the primary storage device for further processing, master assembly and consolidated backup purposes.

Duplication and printing devices can also be provided externally or internally to the digital capture and editing station, or the secondary editing and media creation station. The duplication and printing devices can store the desired product onto physical media, and can also add custom artwork to that media.

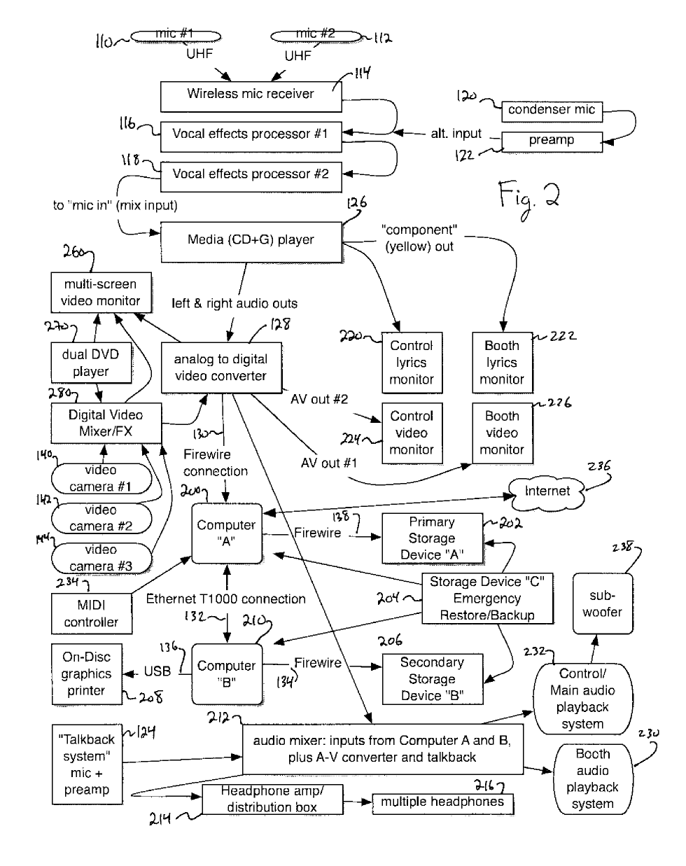

As exemplified in FIG. 2, components and features of a recording system according to an embodiment can be provided within the modular enclosure and can be interrelated in a manner that is adapted for the recording, editing, and production of a high quality recording made of an event performed within the enclosure. Wireless microphones 110, 112 can be operatively associated with a wireless microphone receiver 114 to provide the performer within the enclosure more flexibility during the performance. A condenser microphone 120 connected with a preamplifier 122 can be provided as an alternative means for inputting vocal signals. A “talkback system” 124 with a microphone and preamplifier can also provide audio inputs.

As further shown in FIG. 2, the vocal inputs from microphones 110, 112, wireless microphone receiver 114, and/or condenser microphone 120 and preamplifier 122 can be processed by vocal effects processors 116, 118, in series or in parallel, and fed to an input on a media player/mixer 126 or other device adapted to combine the live inputs from the performer with additional signals such as from a prerecorded sound track. The resulting signal from the media player, or just the prerecorded lyrics of an audio track on the recording if desired, can be fed to one or more of a control lyrics monitor 220, booth lyrics monitor 222, control video monitor 224, and booth video monitor 226. The CD player 126 can also be enabled to send analog output from the CD player 126 to an analog to digital converter 128.

The analog to digital converter 128 can also receive video signals from video cameras 140, 142, 144, with the video signals from the video cameras being selectively combined with video signals provided by a DVD player 270 or other audio-video source, and mixed using a digital video mixer 280. Output from the analog to digital converter 128 can then be sent to one or more of the control video monitor 224 and booth video monitor 226. Output from the analog to digital converter 128 can also be provided to a computer or central processing unit 200, with the interconnection being through a low distortion connection capable of carrying both the video and audio signals, such as through a firewire connection 130.

As shown in FIG. 2, the computer or central processing unit 200 can provide the means for editing the inputs and producing a professional quality recording, which can then be stored on a primary storage device 202, such as any variety of recording media including but not limited to a hard drive, CDs, DVDs, minidisks, etc., and in any desired format. The computer 200, and a second computer 210, interconnected for example with an Ethernet T1000 connection 132, can comprise digital signal processing modules such as the audio and video processing modules described above with at least the capabilities and features listed above. One or both of the computers or central processing units 200, 210 can be connected by firewire connections 134 and/or universal serial bus connections 136 or other types of connections to a printer 208, which can be provided to print graphics on a recording media such as a DVD or CD, and to additional storage devices such as a secondary storage device 206 and an emergency backup storage device 204. The computers can also provide audio inputs to an audio mixer 212, which can combine those audio inputs with inputs from the analog to digital converter 128 if desired and provide audio signals to a booth audio playback system 230 and/or a headphone amplifier and distribution device 214 and headphones 216, and control/main audio playback system 232, optionally equipped with a sub-woofer 238. A MIDI controller 234 can also be provided in communication with one or both of computers 200, 210, to enable input of MIDI data streams, as well as a connection to the internet 236 for transmitting data over the internet.

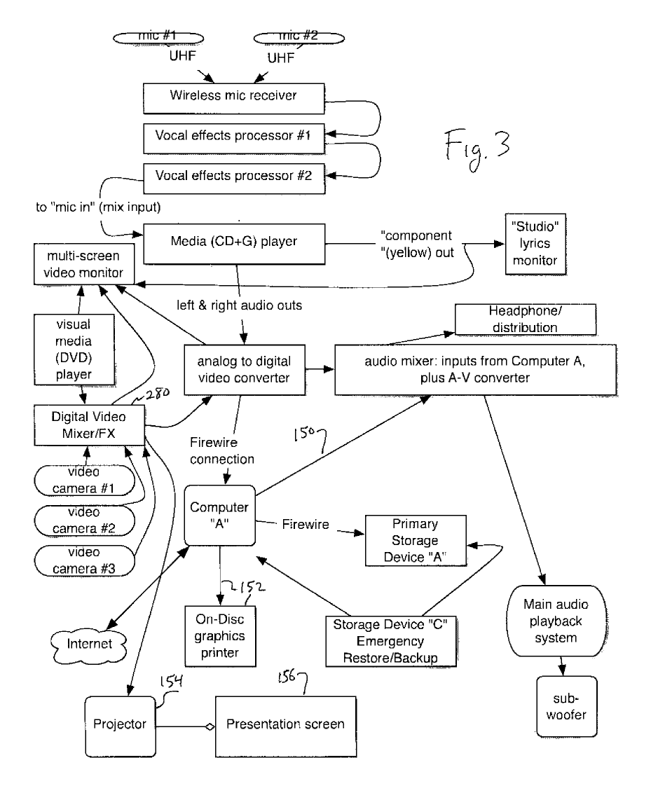

As illustrated in FIG. 3, the computer(s) 200, 210 can be in communication via a communications link 150 directly with the audio mixer 212, as well as an on-disc graphics printer 152. Further optionally, the digital video mixer 280 can include an output to a projector 154, which projects the video signal onto a typical presentation screen 156.

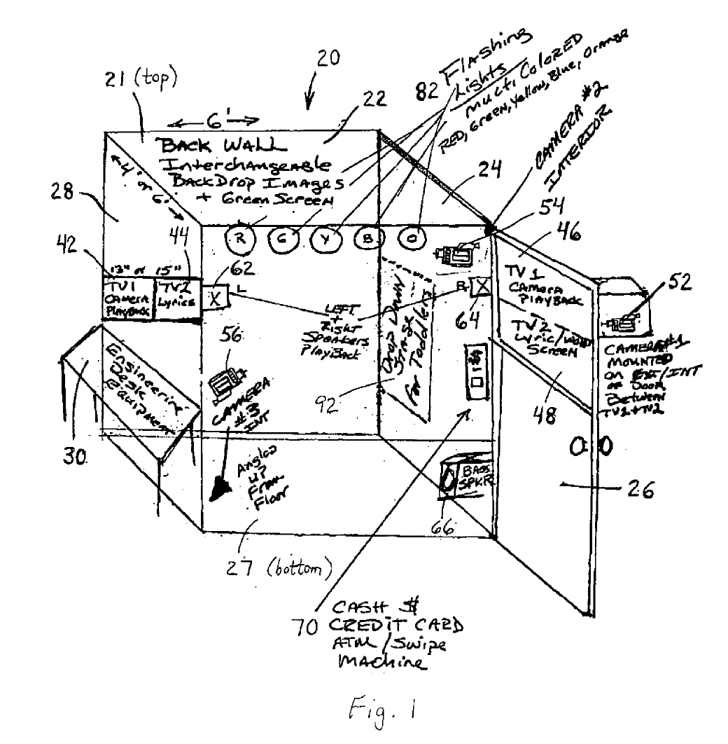

Exemplary embodiments of the recording system can comprise various stand-alone modules, which can range from readily portable modules to larger, semi-permanent or permanent rooms or enclosures that can be transported to a site such as a mall, other retail shopping establishment, etc. One embodiment is shown in FIG. 1, wherein a performance recording modular enclosure 20 comprises some or all of the above-described components and/or features. The enclosure 20 can include a top 21, back wall 22, side walls 24, 28, a front wall/door 26, and a bottom 27. The back wall 22 can comprise an interchangeable backdrop with selectable images, or can comprise a screen onto which can be projected or displayed various stationary and/or moving images and colors, or a colored “chroma-key” screen for superimposing images digitally. TV monitors 42, 44 can be mounted on the back wall 22 or to the side of the back wall 22, or on one or both side walls 24, 28, in a position or positions that allows for easy viewing by a performer within the enclosure 20. The TV monitors 42, 44 can provide for video and/or audio playback of signals from cameras mounted within the enclosure 20 or from other sources such as a CD player or DVD player providing prerecorded inputs such as the lyrics of a song being performed in real time by a performer within the enclosure 20. Additional TV monitors 46, 48 can also be provided on the front wall/door 26 of the enclosure 20, and provide additional playback of signals from cameras and/or prerecorded inputs. Cameras 52, 54, 56 can be mounted at different angles and different vantage points within the enclosure, such as angling up from the floor or bottom 27 of the enclosure 20, angling in from the back wall 22, angling in from the front wall/door 26, or angling in from any of the other side walls 24, 28 or down from the top 21, in order to provide video and/or audio signals based on the performance occurring within the enclosure 20. Additional effects within the enclosure can be provided by speakers 62, 64, 66, and lights 82, as well as other sensory inputs including, but not limited to olfactory stimulation and other tactile stimulation such as breezes created by fans, etc.—all to aid in the production of a recorded performance having the desired effects within the enclosure 20.

An engineering desk and module 30 can be provided as the location of the control equipment such as computers and/or central processing units, digital signal processing modules comprising audio and video processing modules, and also as a work station for a production engineer and music composition station space for the customer if desired. A fold down stage 92 can also be provided if desired to allow performers smaller in stature to appear larger or to place them where desired relative to the background effects and/or audio and video recording equipment. A cash or credit card reader 70 can also be provided for embodiments wherein all of the equipment operates automatically to record a performance within the enclosure 20.

The following described embodiments can include features similar to those described above with reference to FIG. 1, and with their associated names and/or designations being exemplary only, and not intended to limit in any way the potential variations in name, contents and systems of the recording studios, or in the overall configurations of the studios.

Portable: this can be a portable version, intended for small events such as private parties. It can be delivered and transported in a small vehicle, such as a car or minivan.

Mobile: this can be an integrated vehicle version, intended to be dropped off at an event or location, indoors or outdoors. It can be a full featured audio-video setup, similar to the Retail Kiosk version, but configured as a trailer.

Studio: this can be an indoor retail kiosk version, intended for Malls and other shopping or entertainment facilities. It can feature a soundproof booth plus full audio-video recording and editing capabilities. It can also feature a Soundbox™ iMedia™ Station, which allows legal, custom downloads of audio and video recordings, which are burned to disc, or loaded into the customer's storage/playback device.

Pro: this can be a larger, more advanced and feature laden version of a studio of the present invention. It can be intended for permanent or semi-permanent installation at a fixed location, such as a storefront at a Mall. It can be capable of recording a full combo group as a live performance using multi-track audio and multi-camera video. Like the other described embodiments, the Pro version can produce professional, broadcast quality results.

Automatic: this can be an automated version, intended for semi-permanent or temporary installation in a retail or entertainment facility. It can accept cash or credit card payment and create audio-video recordings based on the users' choice of selectable options. It can incorporate Soundbox™ iMedia™ Station capabilities.

The portable version (“Soundbox LE, or Live Edition”) can be broken down and delivered by a small vehicle to any indoor or covered outdoor location. It can also include an engineer/producer to run the equipment and assist the customer. A free-standing backdrop chroma-screen, similar to a portable trade show exhibit wall, can be provided. This screen can provide a background suitable for Compositing, which is adding an electronic visual background. This is similar to the way an animated weather map is added behind a TV forecaster. Printed backgrounds can also be available.

The portable (Soundbox LE) version can comprise up to three areas. 1. The Engineering Station, which will be where the engineer controls the electronics. 2. The Performance Area (or “Studio Area”) which will be where the Artist/customer performs in front of the background screen and in front of the cameras and lighting, and 3. The “Concert Stage” area, which is where the effected and processed audio/video output will be displayed. The Concert Stage area will consist of a large, free-standing, portable pop-up screen, similar to a presentation screen, a high-quality powered sound system which may include two or more satellites (powered loud-speakers) and may include a sub-woofer (low frequency loud-speaker) plus a stand mounted projector which receives and projects a feed from the engineering/video-mixing station.

Sound conditioning baffles, portable and stand mounted, can be set up around the performance area to improve the recorded sound.

Any number of stand mounted video and stage lights can provide back lighting and foreground lighting. One or more tripod mounted CCD (Charged Coupling Device) video cameras can provide feed to the main control board. One or more self-contained, portable equipment racks can be provided adjacent to the performance area, and can comprise electronics such as: Wireless microphone receiver, 2 channels; Vocal Processor (similar to Antares AVP-1); Vocal effects processor (similar to Digitech V300); Karaoke player; Analog to Digital A/V converter (similar to Miglia Directors Cut); Audio interface, media player, additional video monitor screens, remote controllers, Computer and hard drives; Monitor mixer; Headphone amp; Power conditioner; Blank media; supply storage; and a stand mounted teleprompter (karaoke lyric display).

The Mobile version is an embodiment that provides a personal recording studio and iMedia Station built into a climate controlled trailer. The Mobile version can comprise the same electronics and capabilities as the Studio or LE version, but can have the ability to be dropped off at an indoor or outdoor event or location. It can also be provided with a soundproof recording room and a separate engineer/operator station, both inside the trailer. The recording room can be approximately 8′ wide×10′ deep×6.5° tall. It can feature both handheld and stand mounted microphone options, speaker or headphone playback options and a 3-camera live video FX system. An awning can cover a large sidewalk-side entry door and lead into the “foyer” area where the iMedia Station is set up. The engineer can be behind a Plexiglas wall so that customers can view the current recording session without disturbing the engineer. The trailer can have both generator power and “shore power” external hookups. The Soundbox Mobile may also have external audio amplification and video projection capabilities (possibly including one or more solid-state display devices, mounted to the trailer) similar the LE Concert Stage area.

The Studio version is an indoor retail kiosk version, intended for Malls and other shopping or entertainment facilities. This version can be operated by at least one engineer/producer. The Studio version can feature a soundproof booth plus full audio-video recording and editing capabilities. The Studio version can include a Soundbox™ iMedia™ Station where movies, videos and music from major and independent artists as well as recordings and compilations by other artists can be available for legal download/purchase. It can also feature arcade-style games with automated payment.

The Pro version can be a full featured recording studio intended for permanent installation at a fixed location, such as a storefront at a Mall. It can be capable of recording a full combo group as a live performance using multi-track audio and multi-camera video. It can produce professional, broadcast quality results using the latest advances in computer technology.

These advances can include electronic drum kits, which trigger recordings (called “samples”) of real or synthesized drums when sensor pads are struck with drumsticks. It can look and feel familiar to a drummer but may not require lengthy setup time, or the traditional large kit of microphones, pre-amps, compressors, hardware recording console and analog or digital tape recorders. Instruments such as guitar and bass guitar can be processed through computer modeled amplifier simulators. Keyboards and drums can be recorded as MIDI data, allowing fast, extensive and precise editing of a performance plus the ability to change sounds (for example, to change a piano track to orchestra-strings or bagpipes) without replaying the part.

The blending or “mixing” of the elements can be instantly achieved by the use of Custom Style Templates, which can create appropriate sounding mixes for any style of music, which the Engineer/Producer and Artist can then fine tune to taste.

This combination of speed, sonic excellence and custom production presets can produce professional broadcast quality recordings in a fraction of the time, and at a fraction of the price of similar results at traditional recording studios.

CD/DVD duplication and custom designed album artwork (also based on custom templates) can be available on site to complete the package.

The Automatic version can be a fully automated, stand-alone unit capable of producing a karaoke style audio and/or video recording. It is ideal for semi-permanent or temporary installation in a retail or entertainment facility. It can accept cash or credit card payment and create audio-video recordings based on the users' choice of selectable options. It can incorporate Soundbox™ iMedia™ Station capabilities, accessible from outside the recording booth.

The customer can perform inside a recording area that has openings on both sides covered by very heavy acoustic curtains (similar to a photo booth setup). Alternatively, the area can be completely enclosed with regular walls and a door. A sturdy handheld microphone with a flexible steel reinforced cable (similar to the handset in a telephone booth), or a permanent fixed microphone inside the recording enclosure can be used for vocal recording. The camera, teleprompter monitor and video recording monitor can be behind a Plexiglas front wall. Music playback can be through high quality, vandal-resistant indoor/outdoor speakers mounted high on the front wall. A chroma-key (“Green Screen”) background and high intensity front and back lighting can enable the customer to choose a still or full motion electronic background for the video. Preset video special effect sequences can be selectable from “mild to wild” as part of the user definable options. A finished CD/DVD and/or electronic download can be the final output.

While the subject matter has been described in detail with reference to exemplary embodiments thereof, it will be apparent to one skilled in the art that various changes can be made, and equivalents employed, without departing from the scope of the invention.

What is claimed is:

1. A recording system, comprising:
a modular enclosure within which an individual or group can perform audibly and/or visually;
an environment control system adapted for controlling the environment within the modular enclosure during a performance occurring within the enclosure;
an audio recording device;
a video recording device;
a playback system comprising one or more of audio and video playback capabilities;
a digital signal processing system, said digital signal processing system comprising an audio processing module and a video processing module; and
a central processing unit adapted to process inputs from one or more of said audio recording device, said video recording device, said playback system and said digital signal processing system and produce a recording of the audible and/or visual performance performed within said enclosure.

2. The recording system according to claim 1, wherein said modular enclosure is adapted to be carried on a trailer.

3. The recording system according to claim 1, wherein said modular enclosure is adapted to be disassembled and carried to a location using a vehicle such as an automobile or sport utility vehicle.

4. The recording system according to claim 1, wherein said modular enclosure is permanently established at a retail location.

5. The recording system according to claim 1, wherein said environment control system comprises one or more of a climate control system, an interchangeable backdrop with selectable images, olfactory stimulation device, tactile stimulation device, TV monitor adapted to replay one or more of prerecorded audio and visual effects comprising song lyrics, music and video, a fold-down stage adapted to raise the level of a performer within the enclosure, and lighting effects.

6. The recording system according to claim 1, wherein said audio processing module is adapted to process audio signals by one or more of filtering, frequency equalization, dynamic range compression, dynamic range limiting, sibilance attenuation, digital microphone modeling, noise reduction, pitch correction, electronic double tracking, time delay resulting in an echo effect, room equalization, acoustic space simulation resulting in reverb, and voice alteration, transformation and simulation.

7. The recording system according to claim 1, wherein said video processing module is adapted to process video signals by one or more of digital mixing and blending of multiple input sources comprising multiple camera inputs, prerecorded and live video background inputs, negative effects, strobe effects, sepia effects, mosaic effects, black and white effects, chroma keying to replace the real background with digitally generated images and alternate video sequences as background, luma keying, compositing, superimposing, multiple transitions or wipes, and various visual distortion and enhancement effects.

8. The recording system according to claim 1, further comprising:
at least one storage device adapted to store output from the central processing unit.

9. A method of recording a performance, comprising:
providing a modular enclosure or performance area adapted for an individual or group performance therein, wherein the modular enclosure comprises an environment control system adapted for controlling the environment within the modular enclosure during a performance occurring within the enclosure, an audio recording device, a video recording device, a playback system comprising one or more of audio and video playback capabilities, a digital signal processing system, said digital signal processing system comprising an audio processing module and a video processing module, and a central processing unit;
processing inputs received within said modular enclosure from one or more of said audio recording device, said video recording device, said playback system and said digital signal processing system; and producing a recording of the performance.

10. The method of claim 9, wherein the modular enclosure or performance area comprises one or more monitors adapted to playback images and sounds from one or more of the live performance being performed within the enclosure and prerecorded sounds, lyrics and images generated by the playback system, the method further comprising:
providing one or more audio capture devices comprising at least one of wired microphones, and wireless microphones, and one or more video capture devices comprising at least one of single and multiple charge coupled devices with one of variable or fixed focusing and fields;
providing one or more vocal effects processors;
processing live vocal signals from the performance captured by the one or more audio capture devices with the one or more vocal effects processors and producing output vocal signals;
feeding the output vocal signals to a mixing device adapted to combine the live vocal signals with prerecorded sounds generated by the playback system; and
sending one or more of the combined live vocal signals and prerecorded sounds and prerecorded lyrics to the monitors during the performance.

11. The method of claim 9, wherein the modular enclosure comprises one or more monitors adapted to playback images and sounds from one or more of the live performance being performed within the enclosure and prerecorded sounds, lyrics and images generated by the playback system, the method further comprising:
providing one or more audio capture devices comprising at least one of wired microphones, and wireless microphones, and one or more video capture devices comprising at least one of single and multiple charge coupled devices with one of variable or fixed focusing and fields;
providing one or more video effects processors;
processing live video signals from the performance captured by the one or more video capture devices with the one or more video effects processors and producing output video signals;
feeding the output video signals to a mixing device adapted to combine the live video signals with prerecorded images generated by the playback system; and
sending one or more of the combined live video signals and prerecorded images to the monitors during the performance.

12. The method of claim 9, wherein said processing of said inputs received within said enclosure from said audio recording device comprises one or more of filtering the audio signals, equalizing the frequency of the audio signals, performing dynamic range compression on the audio signals, performing dynamic range limiting on the audio signals, performing sibilance attenuation, providing digital microphone modeling, reducing noise, correcting pitch, and simulating various sound environments through time delay, room equalization, and acoustic space simulation.

13. The method of claim 9, wherein said processing of said inputs received within said enclosure from said video recording device comprises one or more of digital video mixing and blending of multiple input sources comprising multiple live camera inputs, prerecorded video background inputs, and live video background inputs, producing a negative effect, producing a strobe effect, producing sepia effect, producing a mosaic effect, producing a black and white effect, chroma keying to replace a real background with digitally generated images or video sequences, luma keying, compositing, superimposing, performing multiple transitions, and producing various visual distortions and enhancement effects.

14. The method of claim 9, further comprising:
printing graphics on the recording of the performance or on packaging for the recording.

15. The method of claim 9, further comprising:
storing output signals produced by the processing of said inputs from the audio and video recording devices, the playback system and the digital signal processing system in a primary storage device.

16. The method of claim 15, further comprising:
storing output from the primary storage device and further processing the output from the primary device, with the further processing comprising at least one of editing and assembling portions of the output and providing further backup for the output.

17. A performance recording system, comprising:
a modular enclosure adapted for an individual or group performance therein;
means for controlling the environment within the modular enclosure during a performance occurring within the enclosure;
means for recording live audio and video within the enclosure;
means for playing back prerecorded audio and video within the enclosure;
means for processing inputs received within the enclosure from said means for recording live audio and video, and combining signals produced by said means for processing inputs and said means for playing back prerecorded audio and video; and
means for recording the performance onto recording media.

18. The system of claim 17, wherein the modular enclosure comprises one or more monitors adapted to playback images and sounds from one or more of the live performance being performed within the enclosure and prerecorded sounds, lyrics and images generated by the means for playing back prerecorded audio and video;
audio capture means;
video capture means;
vocal effects processing means;
means for mixing live vocal signals with prerecorded sounds; and
means for sending one or more of the combined live vocal signals and prerecorded sounds and prerecorded lyrics to audio/video monitors during the performance.

19. The system of claim 17, further comprising:
means for processing live video signals from the performance;
means for feeding live output video signals to a mixing device adapted to combine the live video signals with prerecorded images generated by the means for playing back prerecorded audio and video; and
means for sending one or more of the combined live video signals and prerecorded images to monitors mounted within the enclosure during the performance.

20. The system of claim 17, wherein said means for processing inputs received within said enclosure from said means for recording live audio comprises one or more of means for filtering the audio signals, means for equalizing the frequency of the audio signals, means for performing dynamic range compression on the audio signals, means for performing dynamic range limiting on the audio signals, means for performing sibilance attenuation, means for providing digital microphone modeling, means for reducing noise, means for correcting pitch, and means for simulating various sound environments through time delay, room equalization, and acoustic space simulation.
